(19) United States
(12) Patent Application Publication
(10) Pub. No.: US 2007/0030270 A1
(43) Pub. Date: Feb. 8, 2007

(54) System and method of instruction for cooking a meal

(76) Inventor: Harold L. Rosenberg, Allen, TX (US)

Correspondence Address: HOWISON & ARNOTT, L.L.P, P.O. BOX 741715, DALLAS, TX, 75374-1715, US

(21) Appl. No.: 11/477,155

(22) Filed: Jun. 28, 2006

Related U.S. Application Data
(60) Provisional application No. 60/694,556, filed on Jun. 28, 2005.

(51) Int. Cl. G06T 11/20

(52) U.S. Cl. 345/440

(57) ABSTRACT

A system and method for instructing an individual to prepare a meal includes the steps of separating the preparation of the meal into at least one procedures wherein each of the at least one procedures are associated with a particular portion of the meal. Each of the procedures are then separated into a plurality oftasks necessary to complete the associated procedure. The tasks are grouped for each procedure into a plurality of groups of associated tasks. The groups of tasks have associated therewith a visual identifier. A visual tool is then used to display instructions for preparing the meal. The visual tool includes each of the plurality of groups of tasks in association with their visual identifier.

### REFERENCE TO RELATED APPLICATIONS

This application claims priority to pending U.S. Provisional Patent Application Ser. No. 60/694,556 entitled “METHOD FOR MARKETING AND PREPARING A MEAL” filed Jun. 28, 2005, which is incorporated hereby reference.

### TECHNICAL FIELD OF THE INVENTION

The invention relates to a system and method of instruction for completing a task or series of tasks in parallel, or more particularly, to a method of instruction for preparing a menu including a plurality of menu items using a visual tool.

### BACKGROUND OF THE INVENTION

Conventional methods for instruction in preparing a meal include written recipes and cookbooks or video “cooking shows.” These methods require reading and comprehending complex instructions, identifying ingredients, measuring said ingredients and performing a task with one or two such ingredients within a particular timing and in a particular sequence. The identification and measurement of ingredients and identification of steps to be taken are not generally tied to the sequence and timing of the cooking step. Many people who want to cook are intimidated by these instructions because they are difficult to perform and many people either don't know how to cook or suffer from reading disabilities which make written instructions difficult to follow.

Following conventional recipes requires planning, preparing, measuring and identifying component ingredients to be used in a recipe. These component ingredients are then used in cooking and assembly tasks in a particular sequence with a particular timing. A mechanism is needed which allows an individual to plan, prepare, measure, time and identify component ingredients, identify tasks and steps and the sequence in which to perform all of these tasks and steps in parallel with recipes for various food items.

### SUMMARY OF THE INVENTION

The present invention disclosed and claimed herein, in one aspect thereof, comprises a system and method for instructing an individual to prepare a meal. The preparation of the meal is separated into at least one procedures wherein each of the at least one procedures are associated with a particular portion of the meal. The at least one procedures are separated into a plurality of tasks necessary to complete an associated procedure. The tasks are grouped into a plurality of groups of associated tasks and a visual identifier is then associated with each of the groups. A display tool is used to display instructions for preparing the meal. The display tool includes each of the plurality of groups of tasks in association with its different visual identifier associated with the group for each of the different at least one procedures.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates the manner in which a project such as cooking a menu for a meal may be broken down into various sub-units;

FIG. 2 is an illustration of a visual matrix into which a project may be broken down into a more easily followed processes;

FIG. 3 is a further illustration of the visual matrix describing a project of preparing a particular meal;

FIG. 4 illustrates the manner in which visual identifiers may be used to tie together steps, tasks and components using the present disclosure;

FIG. 5 is a first embodiment for tying a visual identifier to particular components of a task;

FIG. 6 is a further embodiment for tying visual identifiers to components of a particular task;

FIG. 7 is yet another embodiment tying visual indicators to particular components of a task;

FIG. 8a-8d illustrate various manners for illustrating visually identifying tasks according to the present disclosure; and

FIG. 9 is a flow diagram illustrating the process for preparing a menu or task using the visual matrix as illustrated in FIGS. 2 and 3.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

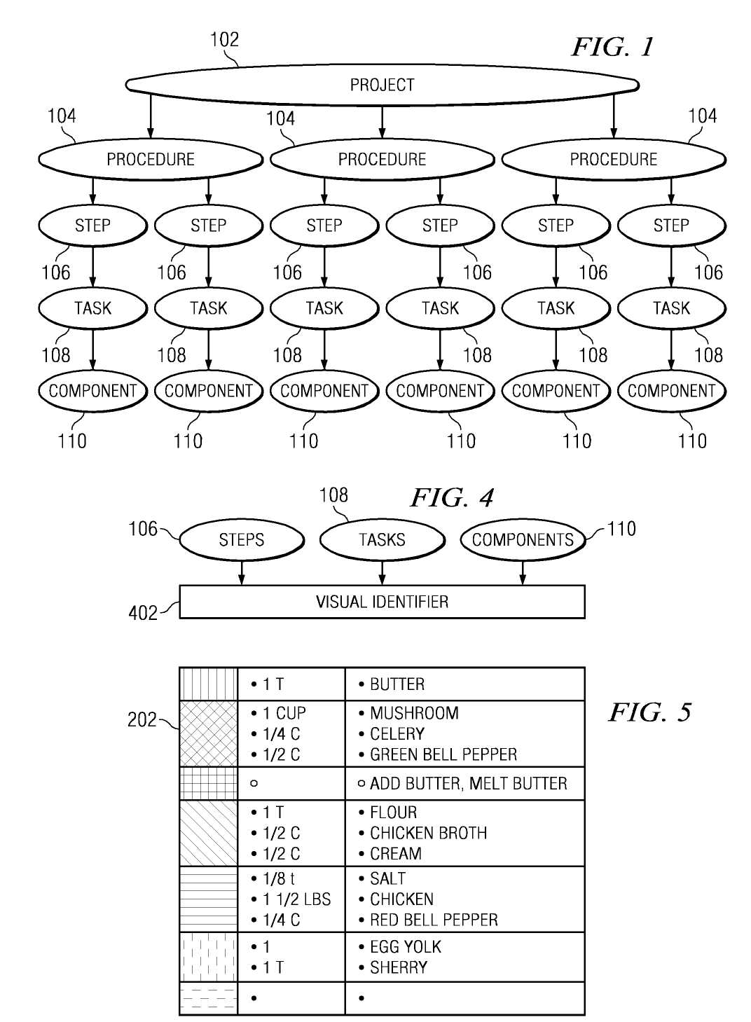

Referring now to FIG. 1, there is a diagram illustrating how a project 102 may be broken down into a number of individual procedures 104, steps 106, tasks 108 and components 110 in such a manner that the method and visual indicators of the present disclosure may be more particular implemented. In the present disclosure, the project may comprise any task that may be broken down in a similar manner. The present embodiment relates to a method for cooking a meal. In this case, the project 102 would comprise a function such as preparing a meal consisting of a main course, a starch and a vegetable. The procedures 104 would include the preparation of each of the individual components of the meal, in this case, the preparation of the main course, the starch and a vegetable. As can be readily seen, the number of procedures can be configured into any number of separate and discreet procedures that must be performed in parallel with each other such that the procedures 104 are ultimately completed at substantially the same time. Each of the individual procedures 104 are further broken down into steps 106 which are groups of tasks 108 that must be performed at substantially the same period of time in order to facilitate the completion of the overall project 102 at a single point in time. In order to facilitate the association of the steps 106, the steps are grouped according to particular associated visual identifiers that enable associated steps to be readily identified with each other.

The individual steps 106 associated with various procedures 104 may be broken down into individual tasks 108 that need to be performed in order to accomplish the steps. The task 108 in the preferred embodiment may comprise tasks such as adding various ingredients to a recipe, sauteeing vegetables, boiling water or any other individual task that must be performed in order to complete the overall project. As will be described more fully herein below, each ofthe individual tasks 108 may also have visual task indicators associated therewith in order to assist an individual in understanding the task to be performed and may further include visual indicators associating the task 108 with a particular step of the project with which the task is involved. Finally, the components 110 are associated with particular tasks 108. The components comprise the physical items necessary to accomplish a particular task 108. For example, in a recipe the components would include the various food ingredients, spices, etc. that would be necessary to prepare the menu.

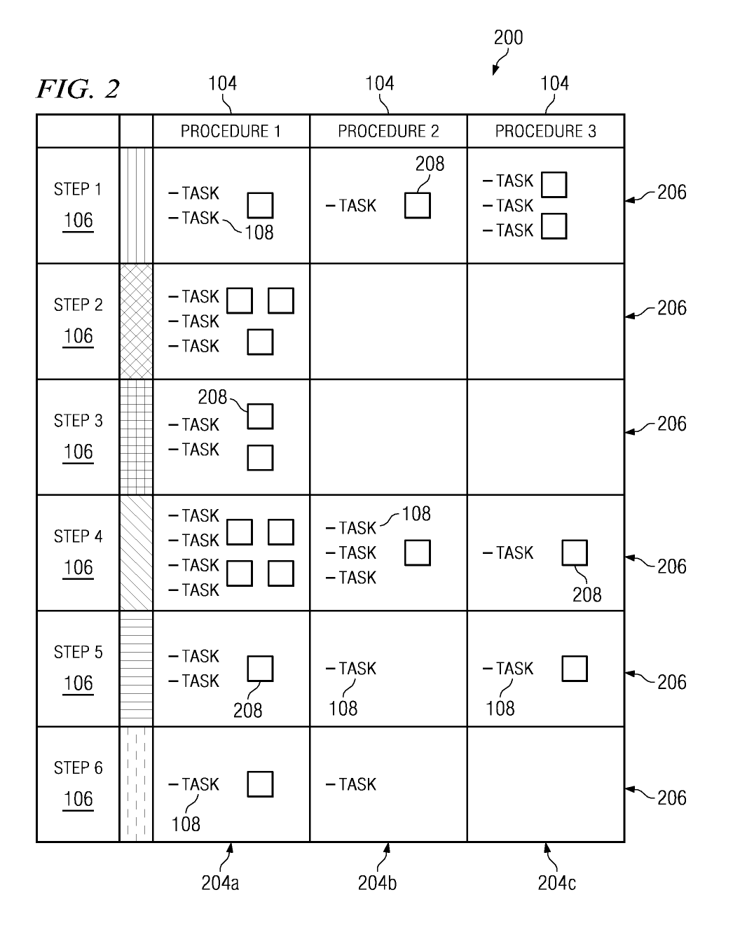

The disclosed process provides a method for instructing and quickly identifying the ingredients, cooking and assembly steps, sequencing of steps and providing a timing scale for the performance of the steps. The method includes a number of instructions that are normally given as distinct, separate tasks that are incorporated into a comprehensive task procedure management tool as illustrated in FIG. 2. The described method and tool overcomes the problems associated with tying together all the necessary tasks (identification of ingredients, identification of step, timing of step, sequence of step) through the use of visual queues. The visual queues consist of a plurality of icons such as colors, symbols, pictures, pictograms or shapes which are coordinated between the task 108 of identification of ingredients, identification of steps and identification of sequence, which have been assigned to a particular timing scale.

Timing is identified by a timing scale tied to a sequence of steps. Sequence steps are identified by their visual queues 202 in a predetermined order, for example, colors in the order of red, orange, yellow, green, blue, indigo and violet. The order of the visual queues is constant. A key to visual queues may or may not be created to facilitate measurement and identification of components referenced to their sequence steps. Packaging with visual queues may or may not be used to further help identify components to their respective task. All tasks referenced to the same sequence of steps are performed at approximately the same time to facilitate parallel processing of tasks 108 for independent procedures 104. A task is a cooking step and a procedure is a recipe to prepare a particular item. This allows for several dishes to be prepared or cooked at the same time, for example, a main dish, a starch dish and a side dish.

One embodiment forthe implementation of a visual tool for implementing the structure of FIG. 1 is illustrated in FIG. 2. While the present discussion describes the implementation of a graphical visual tool for use in the performance of preparing a meal or performance of another project, it should be realized that the visual tool may be implemented in a video format, audio format, graphical format or a combination thereof in order to facilitate the preparation of a meal or performance of a project in accordance with the embodiments described herein. Additionally, other types of media formats in addition to written, such as video, Internet, broadcast, etc. may be used. Each of the plurality of procedures 104 may be broken down into a particular column 204 wherein each of the items included within the column 204 relate to the performance of the procedure 104. Thus, as illustrated in FIG. 2, all of the tasks 108 associated with procedure 1 are included within column 204a. Likewise, all of the tasks associated with the performance of procedure 2 and procedure 3 are located in columns 204b and 204c, respectively. The visual tool 200 illustrated in FIG. 2 is a graphical representation wherein one dimension, in this case, the columns along the x axis represent individual procedures. While the present example has used a visual tool utilizing the columns for association with the particular procedure 104, it will be appreciated that the rows could be associated with particular procedures in any dimensional direction, and the visual tool 200 could be used to illustrate the procedures as long as said association was consistent throughout the visual tool.

The visual tool 200 incorporates a particular sequencing of steps 106 in a second dimension. In the visual tool illustrated in FIG. 2, the sequence of steps 106 are incorporated along the Y axis of the illustration. Each of the rows 206 are associated with a particular step in the overall project of creating a meal and each different procedure 104 has particular tasks 108 associated with each step 106. Thus, each of procedures 1, 2 and 3 have various tasks that must be performed in step 1. Likewise, when step 2 is reached, only procedure 1 has tasks to be performed with respect thereto. No tasks are required to be performed in either of procedures 2 or procedures 3. By associating particular tasks and grouping them according to steps 106, each of the procedures 104 are begun and have tasks 108 performed with respect thereto at a time necessary to enable each of the procedures 104 to be completed at substantially the same time. Thus, no waiting is required for completion of other procedures since each procedure would be completed at substantially the same time.

Each of the steps 106 have associated therewith a particular visual indicator 202. This visual indicator 202 is a manner for grouping together particular tasks and components necessary for completing each of the procedures 104 provides an easy manner for an individual to visually track and follow the instructions with respect to performing of an overall project. The visual identifiers 202 that may be used for identifying and associating the steps 106 within the visual tool 200 may comprise colors, symbols, shapes, icons, pictures, pictograms, or any other means making it easy to visually distinguish between the sequential steps by a user. The visual indicators 202 act as a reference for the sequencing of the steps 106. The visual indicators 202 can use the colors, symbols, icons or shapes, etc., either individually or in various combinations. The sequencing of the visual indicators 202 is fixed in a constant format. For example, if colors are used as visual identifiers, the sequence of colors may be chosen such as red, orange, yellow, green, blue, indigo, violet, and that sequence will be used in the same order to manage the sequence and timing of various tasks in all uses of the visual tool 200 with respect to different projects or meals.

A timing scale is associated with the performance of the steps 106 in order to assist with the completion of the various procedures 104 in substantially the same period of time. Thus, each of the steps 106 having a particular visual indicator 202 associated therewith will be configured to be completed in substantially the same amount of time. For example, each of the steps 1-6 may be configured such that each step is performed in approximately 2-3 minutes. Thus, when placing tasks 108 within each of the sections of the visual tool 200 associated with a particular step 106, the overall timing of each individual step and the overall procedure may be determined based upon the number of tasks 108 placed in the steps 106. This establishment of the time scale will also assist in timing the occurrence of various tasks within each of the procedures 104 to assist in completion of each of the procedures at substantially the same time.

The visual tool 200 additionally incorporates visual task indicators 206 that are associated with some or all of the tasks 108 that are performed within a particular project. Within each intersecting row 204 associated with a particular procedure 104 and column 206 associated with a particular step, there are groups of tasks 108 associated with one or more visual task indicators 208. Each task 108 will comprise a physical task that is to be performed for completing a step of the procedure 104. In the case of a preparation of the menu, the task 108 might comprise items such as, add mushrooms, saute butter, mix flour, etc. The visual task queues 208 comprise a picture of the particular task that is to be performed and would have included in said picture the visual indicator 202 that has been associated with the step that is being performed. Instead of a picture, a drawing or other means for illustrating the tasks to be performed may be used. For example if the visual indicator 202 associated with step 1 in each of the procedures 104 were the color red, the picture of the task would be placed upon a red background within the visual task queue 208. Likewise, if visual indicators of a shape were utilized, the picture could be placed within a particular shape such that if a circle were associated with step 1, the picture would be placed within a circle for the visual task queue 208. It will be appreciated that other visual identifiers to distinguish the tasks may be used.

The method uses the visual tool 200 to illustrate tasks necessary to complete the project. The visual tool 200 uses a graphical configuration wherein one dimension is used to represent the steps 106 associated with a number of individual tasks 108. For example, rows of the table are used to represent tasks w, x, y and z, where task w is the first step for procedure a, task x is the first step of procedure b, task y is the first step for procedure c and task z is the first step for procedure d. Thus, each of the tasks 108 would be performed in a particular step 106a associated with a particular procedure 104 before proceeding to the task associated with the next procedure 104 in the associated step 106. By cycling through the tasks, steps and procedures as illustrated within the visual tool 200, a particular project 102 may be completed by an individual.

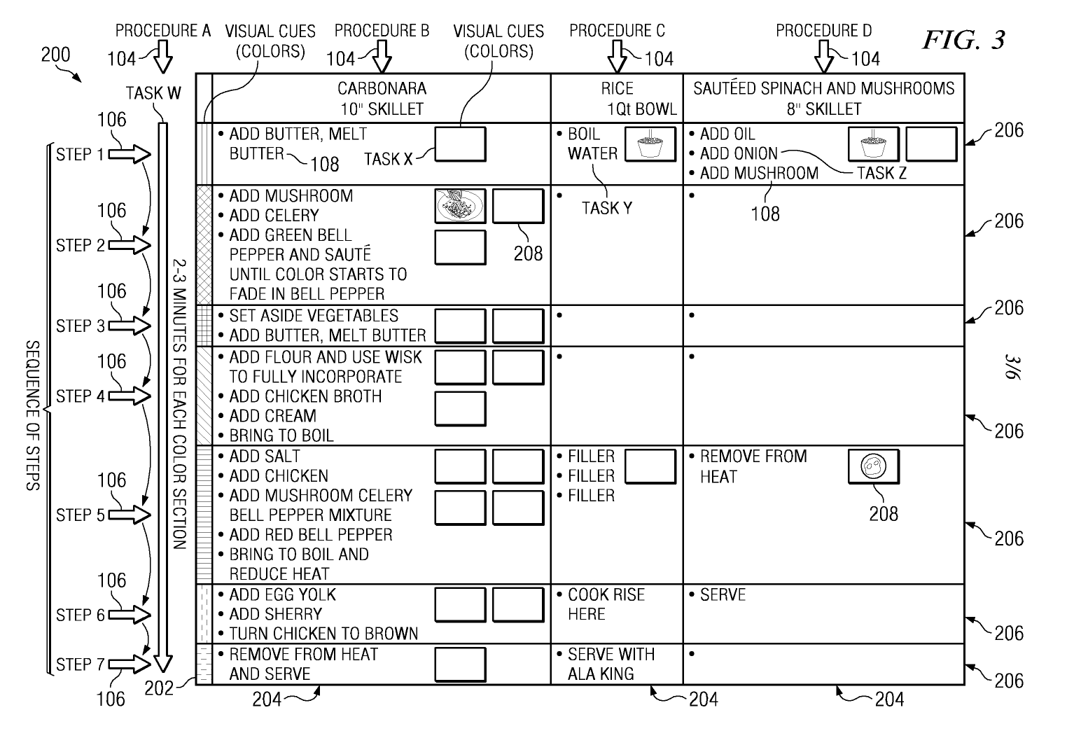

Referring now to FIG. 3, there is illustrated a more particular embodiment of the visual tool 200 describing a method for producing a meal including chicken carbonara, rice and sauteed spinach and mushrooms. In this example, the procedures 104 include the procedure for producing the chicken a la king, the procedure for producing the rice and the procedure for producing the sauteed spinach with mushrooms. The steps for producing each of the foods associated with the procedures 104 are broken down into several different steps 106. Step 1 has a red visual indicator 202 associated therewith, step 2 has an orange visual indicator 202 associated therewith, step 3 has a yellow visual indicator 202 associated therewith, step 4 has a green visual indicator 202 associated therewith, step 5 has a blue visual indicator 202 associated therewith, step 6 has a purple visual indicator 202 associated therewith and step 7 has an indigo visual indicator 202 associated therewith. Other colors or indicators may of course be used.

An individual preparing a meal according to the visual tool 200 would begin with the first procedure 104a associated with the chicken a la king at step 1 having the red visual indicator 202. The initial task 108 is to add and melt butter. The task indicator 208a associated with this task 108 illustrates a pat of butter within a skillet that is placed upon a red background to tie it in with the visual indicator 202 for step 1. Likewise, the first task 108 for procedure 2 and preparing rice comprises boil water. The visual indicator 208b associated with this task 108 comprises a pot with water also being placed upon a red background. This process continues for each of the various tasks within the procedure columns 204 and step rows 206. As can be seen, each of the tasks indicators 208 includes a picture of the task to be performed that is placed upon a similarly colored background that is associated with the particular step 106 which is presently being performed. Upon completion of each of the tasks associated with step 7 for all of the procedures, the user would be able to. serve a meal including chicken carbonara, rice and sauteed spinach and mushrooms. In the present example, the time associated with each of the steps 106 would comprise 2-3 minutes for each section. Thus, all of the tasks associated with step 1 having a red color would be performed in 2-3 minutes and so forth, for each of the steps indicated.

Referring now to FIG. 4, the use of the visual identifiers 402 of various types enable a user to easily determine steps 106, tasks 108 and components 110 that are associated with each other in a logical fashion that eases understanding of the preparation of a meal or the performance of any other project 102 indicated within the visual tool 200. The actions and associated components are visually associated with each other rather than requiring a user to read and comprehend a written recipe. This enables the user to rely upon their visual comprehension skills rather than their reading comprehension skills.

Referring now to FIGS. 5-7, there are illustrated various manners by which the components 110 may be uniquely identified with visual indicators that assist an individual in preparing a meal as described by the visual tool 200. A series of visual queues are referenced within the visual tool 200 for the identification of components to be used for a task in accordance with the sequence order ofthe visual tool described with respect to FIG. 3. For example, a meal component (ingredient) such as mushrooms, would be assigned a visual indicator such as the color yellow. The method may or may not define the component ingredient by its measure (such as one cup) or by its preparation (such as slice). The method may or may not incorporate a reference key for the assignment of visual indicators 202 to components which the visual queue identifies. For example, a table listing all of the ingredients for the meal might list the measure, ingredient and color together to identify the component as illustrated in FIG. 5. FIG. 5 illustrates a number of different components including butter, mushrooms, celery, green bell pepper, flour, chicken broth, etc. Each of these components are associated with a particular visual identifier 202 that is associated with the corresponding steps 106 in the visual tool 200 in which the component is used for preparing the meal. In this manner, an individual preparing a meal according to the visual tool 200 would quickly know which components were going to be needed with respect to a particular preparation step 106 by looking at the visual tool 200 and the component listing of FIG. 5.

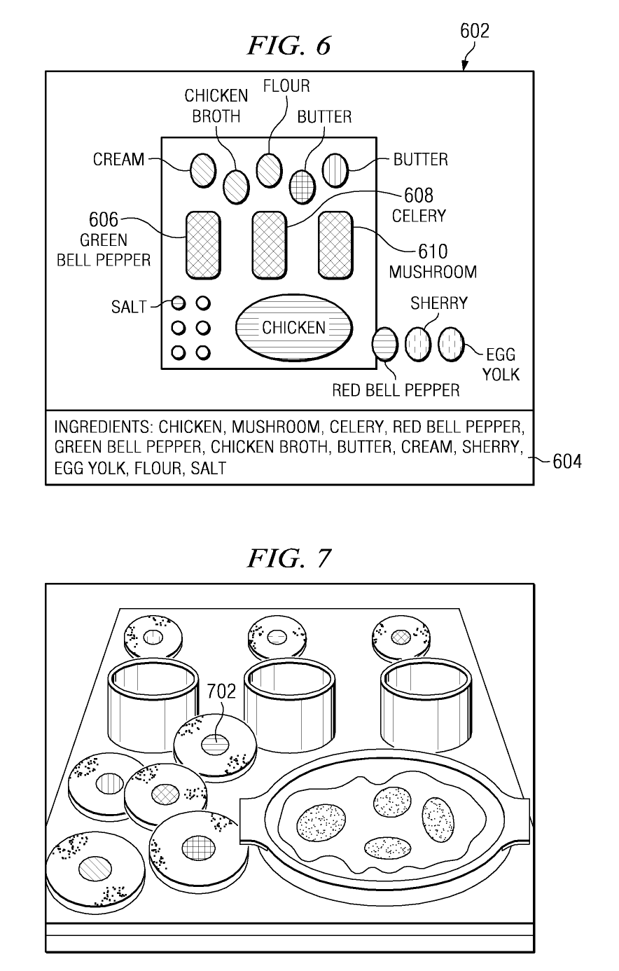

Referring now to FIG. 6, a diagram 602 may also be provided that illustrates a list 604 of the ingredients with or without necessary measures. The diagram 602 would include a picture of a tray or container that was provided with the visual tool 200 and would include color designations associating particular food components 110 with a particular step 106 visual identifier 202. Thus, as illustrated in FIG. 3, the bell pepper 606, celery 608 and mushrooms 610 are each provided with a single visual identifier color associated therewith that is consistent with the visual identifier color with which these components are used within step 2. Other components within the diagram 602 would also be similarly identified with a common visual identifier to indicate they were used within a same step 106 such as the color identifier 202 that was associated with the particular step in which the components were utilized. This would allow a user to quickly determine the components associated with a step by matching the visual identifiers 202.

Finally, a person utilizing the described method and the visual tool 200 may utilize the method such that the components 110 come in a prepackaged fashion wherein the components 110 are marked with the visual indicators 202 that a person completing the process described in the visual tool 200 could use to identify the components associated with a particular step as illustrated in FIG. 7. In this case, each of the components have a colored circle 702 located thereon that is associated with the particular step 106 in which the component is used for preparation of the meal. Thus again a user merely pulls the components of a similar color when performing a particular step.

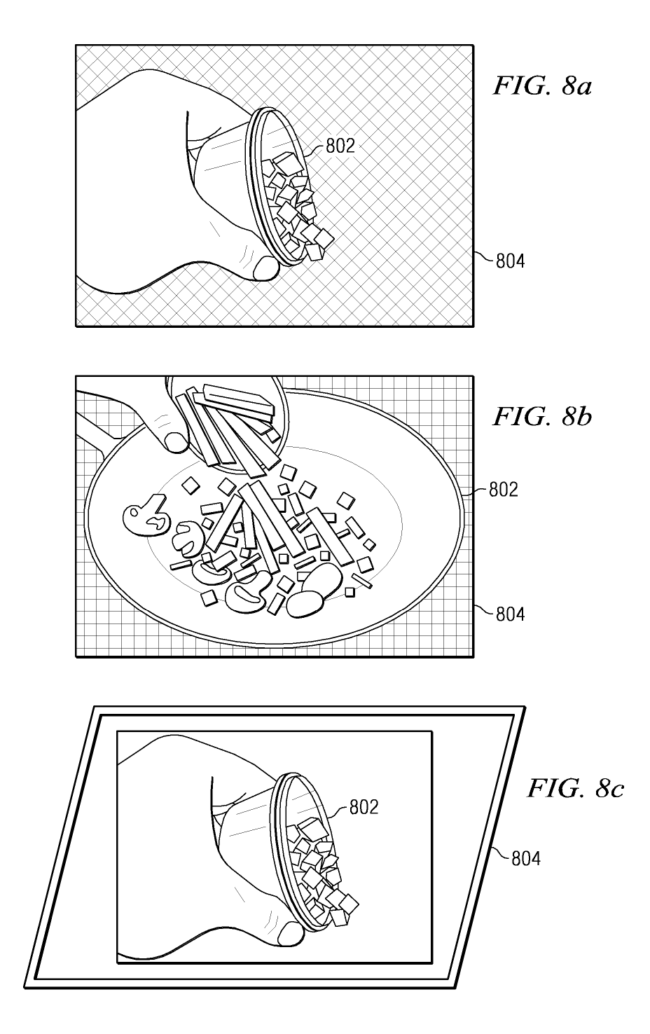

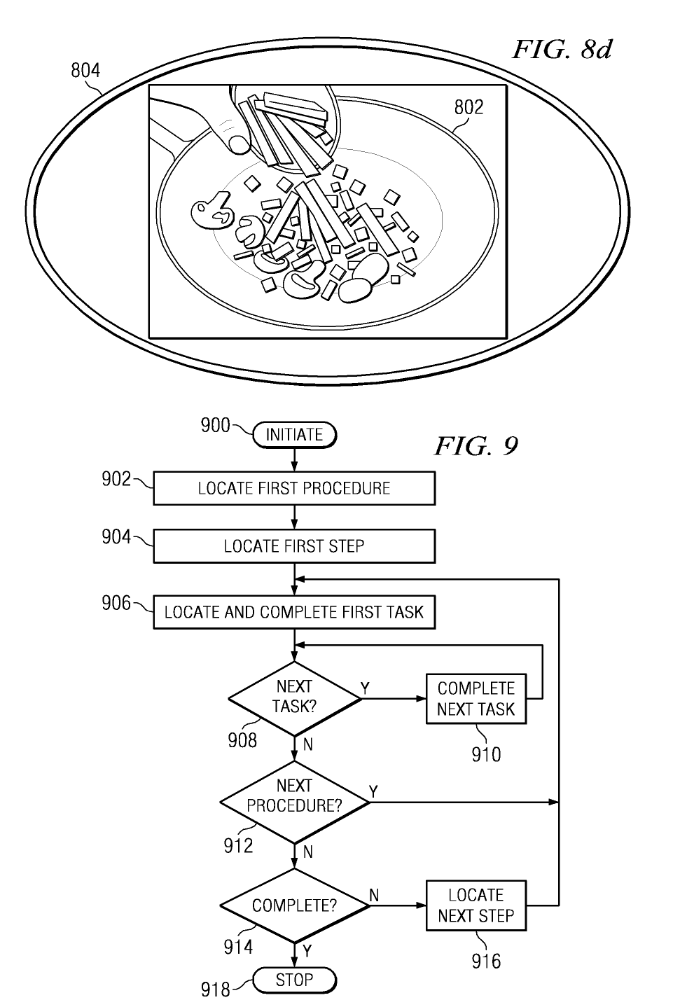

The method incorporates a written, audio/visual and/or pictorial description of the task to be completed as a step in the procedure as illustrated in FIGS. 8a-8d. The identifiers comprise the visual task identifiers 208 described previously in FIGS. 2 and 3. A pictorial representation 802 of the task is placed upon a background identifier 804 that is associated with the particular step 106 within the process. FIGS. 8a and 8b illustrate the pictorial representation 802 upon a colored visual identifier 804. FIGS. 8c and 8d illustrate the pictorial representation 802 of the task upon a shape identifier 804. The task is identified by cross-reference to the visual queue such as color, which also references the sequence, and identification of component to be used. All tasks identified by the same visual indicator (such as the color yellow) are performed at approximately the same time to facilitate the completion of independent tasks in parallel procedures 104.

Referring now to FIG. 9, there is illustrated a flow diagram ofthe process for utilizing the visual tool 200 described with respect to FIGS. 2 and 3 to perform a particular project 102 such as the preparation of a meal. Upon initiation of the process at step 900, an individual locates at step 902 the first procedure 104 that is to be performed for the project. The user next locates the first step associated with the first procedure at step 904. The user locates and completes at step 906, the first task associated with the first step. Inquiry step 908 determines if additional tasks are present to be completed within the present step. If so, the user will complete the next task at step 910 and control returns to inquiry step 908 to determine if yet further tasks exist for performance. Once inquiry step 908 determines that no additional tasks are available for performance, inquiry step 912 determines if there exists a next procedure for the project. If so, control passes back to step 906 and the first task is located and completed with respect to the next procedure at step 906. If inquiry step 912 determines that a next procedure is not available, inquiry step 914 determines if the project is completed. If not, control will pass to step 916 wherein the next step associated with the first procedure is located at step 916. Control passes again to step 906 wherein the first task is completed with respect to the located next step at step 906. If inquiry step 914 determines that the project has been completed, the process is completed at step 918. Cycling through the visual tool 200 in this manner a user can prepare a meal or perform any other illustrated project.

Thus, by merely following the process flow indicated with respect to the visual tool 200, the user may complete a complicated project such as the preparation of a meal wherein multiple procedures may be performed in parallel and these multiple procedures may be completed at substantially the same point in time. Additionally, the user is assisted in the performance of the project by visual indicators that indicate various tasks to be performed and components to be used at particular points in time in order to achieve the completion of the project and its component procedures at substantially the same point in time. Thus, the present invention provides a system and method of instruction for completing a task or a series of tasks in parallel wherein said tasks contain multiple steps such that the timing of the steps, sequence of the steps and identification of the steps and components is important, for example, in the preparation in cooking of a meal. The process provides for the preparation, assembly and/or cooking of a meal in a preferred embodiment, however, the method is also applicable to other tasks wherein conveying instructions for timing, sequencing and identifying steps is important.

It will be appreciated by those skilled in the art having the benefit of this disclosure that this invention provides a method instruction for preparing a meal. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method for instructing an individual to prepare a meal comprising the steps of:
separating the preparation of the meal into at least one, each of the procedures associated with a portion of the meal;
separating each of the at least one procedures into a plurality of tasks necessary to complete the procedure;
grouping the tasks for each procedure into a plurality of groups of associated tasks;
associating a different visual identifier with each of the plurality of groups; and
displaying in a visual tool instructions for preparing the meal, the visual tool including each of the plurality of groups of tasks in association with the different visual identifier associated with the group for each of the at least one procedures.

2. The method of claim 1, wherein the visual identifiers comprise at least one of colors, shapes, symbols, pictures, pictograms or icons.

3. The method of claim 1, further including the steps of:
identifying components associated with each of the plurality of tasks;
associating the visual identifier associated with a group a task with each of the identified components.

4. The method of claim 3, wherein the step of associating further comprises the step of associating further comprises the step of packaging the components to include the associated visual identifiers.

5. The method of claim 1, further including the step of arranging the plurality of groups in the visual tool in a sequence necessary to prepare the meal.

6. The method of claim 1, further including the step of establishing a timing scale such that each of the groups have a selected period of time associated with the performance of the tasks associated with the groups.

7. The method of claim 6, wherein the selected period of time is variable.

8. The method of claim 1, wherein the step of displaying further comprises the steps of:
arranging the at least one procedure to be performed along a first direction in the display tool;
arranging the plurality of groups in a predetermined sequence along a second direction in the display tool;
arranging the grouped tasks at an intersection between the at least one procedure and the groups; and
displaying the at least one procedure, the plurality of groups and the grouped tasks according to the arrangements.

9. The method of claim 1, further including the step of:
associating a graphical representation of a task with the visual identifier associated with the group of the task; and
displaying the graphical representation and the associated visual identifier within the display tool.

10. The method of claim 1, wherein the step of displaying further comprises the step of displaying each of the at least one procedure in parallel.

11. A method for instructing an individual to prepare a meal comprising the steps of:
separating the preparation of the meal into at least one procedures, each of the at least one procedures associated with a portion of the meal;
separating each of the at least one procedures into a plurality of tasks necessary to complete an associated procedure;
grouping the tasks for each of the at least one procedures into a plurality of groups of associated tasks;
associating a different visual identifier with each of the plurality of groups;
associating a graphical representation of at least one task with the visual identifier associated with the group of the task;
displaying in a visual tool instructions for preparing the meal, the visual tool further displaying each of the plurality of groups of tasks in association with the different visual identifier associated with the group for each of the at least one procedures, the visual tool further displaying each of the at least one procedures in parallel, the visual tool further displaying the graphical representation and the associated visual identifier for the at least one task arranging the plurality of groups in the visual tool in a sequence necessary to prepare the meal;
identifying components associated with each of the plurality of tasks; and
associating the visual identifier associated with a group a task with each of the identified components.

12. The method of claim 11, wherein the visual identifiers comprise at least one of colors, shapes, symbols, pictures, pictograms or icons.

13. The method of claim 11, wherein the step of associating further comprises the step of associating further comprises the step of packaging the components to include the associated visual identifiers.

14. The method of claim 11, further including the step of arranging the plurality of groups in the visual tool in a sequence necessary to prepare the meal.

15. The method of claim 11, further including the step of establishing a timing scale such that each of the groups have a selected period of time associated with the performance of the tasks associated with the groups.

16. The method of claim 15, wherein the selected period of time is variable.

17. The method of claim 11, wherein the step of displaying further comprises the steps of:
arranging the at least one procedures to be performed along a first direction in the display tool;
arranging the plurality of groups in a predetermined sequence along a second direction in the display tool;
arranging the grouped tasks at an intersection between procedures and the groups; and
displaying the at least one procedures, the plurality of groups and the grouped tasks according to the arrangements.

18. The method of claim 11, wherein the step of displaying further comprises the step of displaying each of the at least one procedures in parallel.

19. An apparatus for instructing an individual to prepare a meal, comprising:
a visual tool, said visual tool further comprising:
at least one procedures relating to preparation of the meal arrange along a first axis in the visual tool, each of the at least one procedures associated with a portion of the meal, the at least one procedures each arrange in parallel with each other;
a plurality of groups of associated steps arranged along a second axis in the visual tool, each of the groups comprising a plurality of tasks necessary to complete each of the at least one procedures, the tasks assigned to individual groups to enable each of the at least one procedures to be completed at substantially a same time, wherein the plurality of groups are arranged in a sequence and have a selected time associated therewith; and
a plurality of visual identifiers each uniquely associated with one of the plurality of groups.

20. The apparatus of claim 19, wherein the visual identifiers comprise at least one of colors, shapes, symbols, pictures, pictograms or icons.

21. The apparatus of claim 19, further including a listing of ingredients, each of the ingredients having a visual identifier associated with one of the plurality of groups associated therewith.

22. The apparatus of claim 21, further including ingredients packaged to include the associated visual identifiers.

23. The apparatus of claim 19, wherein the plurality of groups are further arranged according to a timing scale such that each of the groups have a selected period of time associated with the performance of the tasks associated with the group.

24. The apparatus of claim 23, wherein the selected period of time is variable.

25. The apparatus of claim 19, wherein the grouped tasks are arranged at an intersection between procedures and the groups.

26. The apparatus of claim 19, wherein at least one of the tasks include a graphical representation of a task associated with the visual identifier associated with the group of which the at least one task is a member.
